(19) United States
(12) Patent Application Publication
(10) Pub. No.: US 2013/0062577 A1
(43) Pub. Date: Mar. 14, 2013

(54) CARBON NANOTUBE SUSPENSION AND SUPERHYDROPHOBIC FILM PREPARED THEREFROM

(71) Applicants: JIANG-JEN LIN, TAIPEI (TW); CHAO-PO HSU, TAIPEI (TW)

(72) Inventors: JIANG-JEN LIN, TAIPEI (TW); CHAO-PO HSU, TAIPEI (TW)

(73) Assignee: NATIONAL TAIWAN UNIVERSITY

(21) Appl. No.: 13/310,837

(22) Filed: Dec. 5, 2011

(30) Foreign Application Priority Data
Sep. 14, 2011 (TW) 100133054

(51) Int. Cl. H01B 1/24; B82Y 30/00

(52) U.S. Cl. 252/511; 977/902

(57) ABSTRACT

A carbon nanotube suspension includes a plurality of carbon nanotubes and a block copolymer dispersant which are evenly distributed in a solvent, wherein the block copolymer includes a hydrophobic block and a functional group block, such that the carbon nanotubes react with the functional group block to form covalent bonds directly without undergoing chemical modification. The carbon nanotube suspension is effective in preparing a superhydrophobic film without undergoing chemical modification or the presence of a fluorine-containing compound. The superhydrophobic film thus prepared is of a tough stable structure and remains superhydrophobic when subjected to lengthy immersion treatment, exposure to a strong acid-base environment, or physical abrasion and polishing.

### CROSS-REFERENCE TO RELATED APPLICATION

This non-provisional application claims priority under 35 U.S.C. §119(a) on Patent Application No(s).100133054 filed in Taiwan, R.O.C. on Sep. 14, 2011, the entire contents of which are hereby incorporated by reference.

### FIELD OF TECHNOLOGY

This invention related to a carbon nanotube suspension, more particular, to a superhydrophobic film carbon nanotube suspension.

### BACKGROUND

In the nature world, the superhydrophobic is shown on the leaf surface of the plant because of its unique microstructure and the surface chemical property, for example, leaf of lotus and the leaf of cabbage. When the ball shape water drops rolling on the surface of the leaf, the dust will be clean up simultaneously. This cleaning method, which is scouring by water instead of manpower, called self-cleaning feature or lotus effect. This surface phenomenon of the lotus leaf is caused by two factors: low surface tension and high surface roughness.

When the liquid dropped on the solid surface, the included angle between the solid surface and the tangent line of the liquid drop is the so-called contact angle (θ). As the boundary tension of the liquid-solid (which is the solid surface energy) increased, the contact angle is decreased. It indicates that the solid surface is easy to moisten. When the contact angle is equal to 0 degree, it means that the solid surface can be fully moistened by the liquid. On the contrary, as the boundary tension of the liquid-solid decreased, the contact angle is increased. It indicates that the solid surface is difficult to moisten. When the contact angle is equal to 180 degrees, it means that the solid surface cannot be moistened by the ball shape liquid drop.

Moreover, the contact angle on the liquid surface increased as the solid surface becomes rougher. The effect of the surface roughness vs. moisture is, for example, the absorbed gaseous atom exited stably by the indent surface of the nanodiameter. On the macro view, it can be thought as a layer of stable gaseous thin film that making the liquid unable to direct contact with the solid surface. The contact surface of the liquid and the solid is a hybrid interface, solid surface in part and gaseous in part. The contact angle increased since no coherence moist phenomenon on the gap of liquid drop and the rough surface.

The self-cleaning feature can be practiced in numerous applications, includes outer walls of buildings and the building material such as glass, wood (stone) material or tile, etc., baking finish and glass, plastic, etc. The consumption of water is reduced and the cleaning surface is maintained any time. However, although the surface is water proof after coating the coating which is used currently, the water drop cannot roll efficiently to clean up and remove the dust. Thus, there is no self-cleaning effect. Therefore, it is necessary to develop a hydrophobic coating surface with low surface energy and roughed surface structure. Thus, the superhydrophobic self-cleaning effect just like the leaf of the lotus can be achieved.

Therefore, in the market, the development of the self-cleaning coating (also called a hydrophobic coating) material is in the limelight. For example, the self-cleaning coating reduces the maintaining cost when it is applied to a curtain glass of the buildings, apparatus of kitchen or bathroom; improves product quality and efficiency when it is applied to the solar cell, surface of the satellite antenna and front windscreen of the vehicle; reduces the fuel consumption and the pollution production caused by the air friction force when it is applied to the hull of the ship and the flight vehicle. Currently, the development of the self-cleaning coating material focuses on the multi-layered composite structure to achieve the hydrophobic self-cleaning function. The multi-layered structure has different features, such as adhesion, roughed surface structure, ultra low surface energy, respectively. However, there are some problems that the developed self-cleaning coating material needs to face, such as poor adhesion, insufficient hardness, poor transparency and durability insufficient.

Usually, the feature of the self-cleaning coating material is that the contact angle with the static state of water is 90 degree or above. The hydrophobic polymer material has been used for decades years, such as polytetrafluoroethylene (PTFE) or polypropylene (PP). However, the application of these materials is limited since the hydrophobicity and the mechanism property is not as good as the engineering material or the high cross-linking coating. For example, the static state contact angle between PP and water is only 100 degrees. The static state contact angle between PTFE (currently largest hydrophobicity polymer material) and water is 112 degrees. Therefore, the research of the superhydrophobic coating obtains much attention. The typical definition of the superhydrophobic coating is that the static state contact angle with water is higher than 140 degrees. (Nun, Oles and Schleich, Macromol. Symp., 187 (2002) 677-682).

In the past, applying the carbon nanotube to the superhydrophobic research needs to proceed the chemical modification or complex procedure, such as prepared by the layer-by-layer deposition or chemical vapor deposition (CVD). However, the procedure of the preparing method, such as Chemical vapor deposition (CVD), is very complicated. There has no economic effect for mass production. Typical chemical modification is grafting a fluorine-containing compound on the surface of the carbon tube, wherein the fluorine-containing compound has property of low surface energy and good for stabilizing the dispersed carbon in the solvent. TW Patent Publication No. 200500429 discloses a hydrophobic coating comprising reactive inorganic nanoparticles. There is a coating composition comprising reactive nanoparticles having reactive organic groups and non-polar groups on its surface. The reactive group and the non-polar group are grafted on the surface of the nanoparticle by chemical method, such as a nanoparticle with acrylate group (reactive group) and perfluoroalky chain (non-polar group). The reactive group makes the nanoparticle having partial cross-linked network. The non-polar group makes the coating having surface hydrophobic property. However, the fluorine-containing compound is toxic, expensive and complicated synthesizing procedure. Recently, the global environmental protection subject is growing. It is an urgent subject to develop a superhydrophobic material for carbon nanotube, prepared by a method tallied with the environmental protection and economical effect. Therefore, it is a strong need to make the superhydrophobic coating more easy to use and having controlled hydrophobic and lengthy duration (hardness, polishing-proof and acid/base-proof.

Therefore, this invention desired to disclose a carbon nanotube suspension which is effective in preparing a superhydrophobic film without undergoing chemical modification or the presence of a fluorine-containing compound and the superhydrophobic film thus prepared is of a tough stable structure and remains superhydrophobic when subjected to lengthy immersion treatment, exposure to a strong acid-base environment, or physical abrasion and polishing.

### SUMMARY

In view of the disadvantages of the prior technology, applicant realized that it is not perfect and try his best to overcome the disadvantages above-mentioned. Relying on the experiment in this technology field, applicant developed a carbon nanotube suspension to achieve the purpose of forming the superhydrophobic film.

One purpose of this invention is to provide a carbon nanotube suspension which is effective in preparing a superhydrophobic film without undergoing chemical modification or the presence of a fluorine-containing compound. The superhydrophobic film thus prepared is of a tough stable structure and remains superhydrophobic when subjected to lengthy immersion treatment, exposure to a strong acid-base environment, or physical abrasion and polishing.

To achieve the purpose above-mentioned, this invention provides a carbon nanotube suspension including a plurality of carbon nanotubes and a block copolymer dispersant which are evenly distributed in a solvent, wherein the block copolymer includes a hydrophobic block and a functional group block, such that the carbon nanotubes react with the functional group block to form covalent bonds directly without undergoing chemical modification.

The carbon nanotube suspension above-mentioned further comprises a thermosetting resin.

In the carbon nanotube suspension above-mentioned, the thermosetting resin is epoxy resin.

In the carbon nanotube suspension above-mentioned, the epoxy resin is bisphenol-A diglycidyl ether.

In the carbon nanotube suspension above-mentioned, the functional group is a functional group with lone-pair electrons.

In the carbon nanotube suspension above-mentioned, the functional group is amino group.

In the carbon nanotube suspension above-mentioned, the hydrophobic block is a polyolefin with 10 to 30 carbon atoms.

In the carbon nanotube suspension above-mentioned, the polyolefin is a polyisobutylene.

In the carbon nanotube suspension above-mentioned, the block copolymer is a polyisobutene amine copolymer.

In the carbon nanotube suspension above-mentioned, the polyisobutene amine copolymer is obtained by reacting the polyisobutylene-g-maleic anhydride and poly(oxypropylene)-triamine.

In the carbon nanotube suspension above-mentioned, no fluoride is contained.

In the carbon nanotube suspension above-mentioned, the weight percent of the block copolymer dispersant and the solvent is lower than 5 wt %.

In the carbon nanotube suspension above-mentioned, the weight percent of the carbon nanotube and the solvent is lower than 1 wt %.

In the carbon nanotube suspension above-mentioned, the weight percent of the block copolymer dispersant, the carbon nanotube and the thermosetting resin is 0.1˜100:1:20˜500.

Another purpose of this invention is to provide a superhydrophobic film, which is obtained by coating and then drying the carbon nanotube suspension above-mentioned. Its static state contact angle with water is 140 to 160 degree.

In the superhydrophobic film above-mentioned, the conductivity is 10⁻⁴ to 10¹ (S/cm).

In the superhydrophobic film above-mentioned, the hydrophobic or conductivity is controllable by adjusting the weight percent of the block copolymer dispersant and the carbon nanotube.

The carbon nanotube superhydrophobic film mentioned in the prior art is prepared by treating a low surface energy material containing fluorine or long chain alkyl group with chemical modification or chemical deposition to arrange the carbon nanotube. The procedure is complicated. The carbon nanotube suspension disclosed in this invention disperses the carbon nanotube in the solvent uniformly through the block copolymer dispersant. And then, by using simple coating and solvent evaporating, the superhydrophobic film can be obtained by coating the suspension on the substrate. The block copolymer includes a hydrophobic block and a functional group block, such that the carbon nanotubes react with the functional group block to form covalent bonds directly without undergoing chemical modification. The hydrophobic block can uniformly disperse the carbon nanotube in the solvent and preserve the hydrophobic property because of the low surface energy. This invention can resolve problems, such as fluorine-containing material pollution, high cost and complicated procedure, etc. This invention is valuable and can be applied to the electronic material, coating of buildings and aerospace technology, etc.

The carbon nanotube suspension of this invention is effective in preparing a superhydrophobic film without undergoing chemical modification or the presence of a fluorine-containing compound. The superhydrophobic film thus prepared is of a tough stable structure and remains superhydrophobic when subjected to lengthy immersion treatment, exposure to a strong acid-base environment, or physical abrasion and polishing.

### BRIEF DESCRIPTION

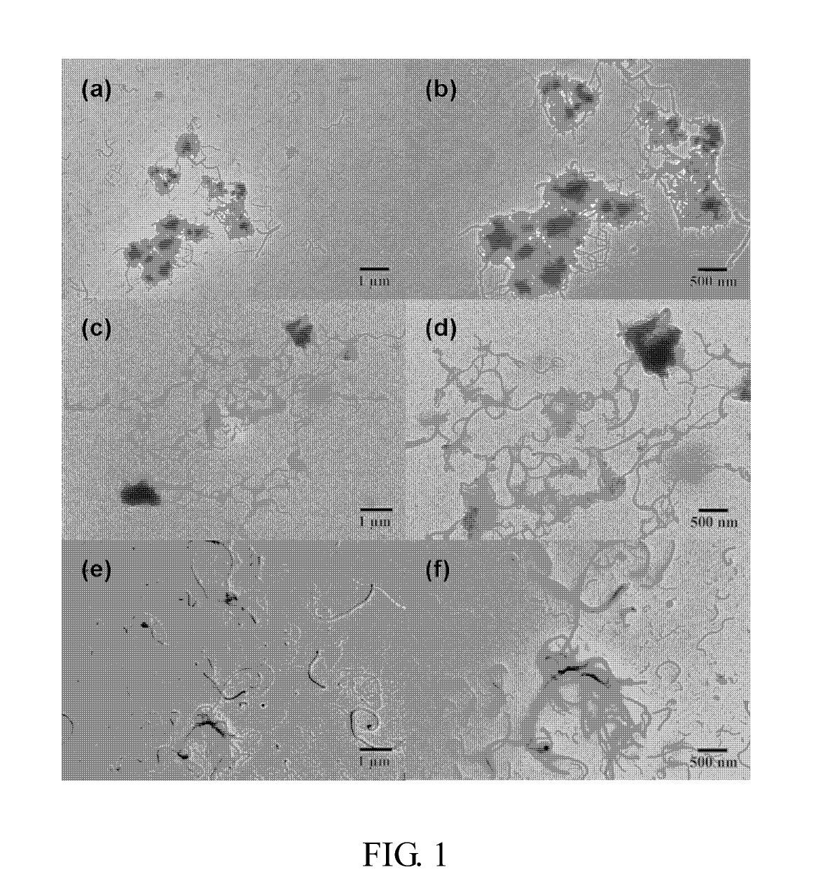

FIG. 1 is the Transmission Electron Microscopy (TEM) picture showing the dispersion of the carbon nanotube dispersed in the solvent;

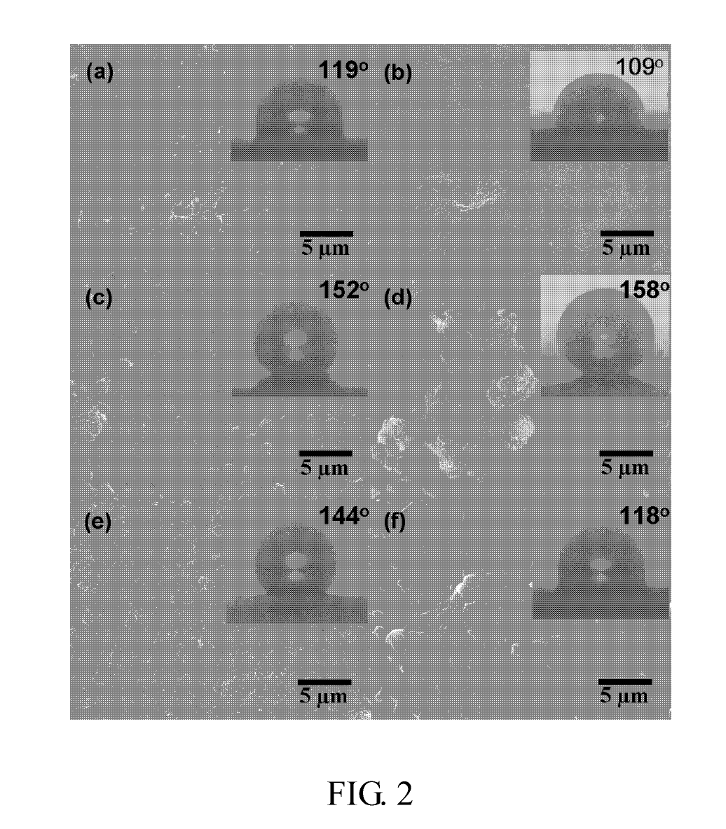

FIG. 2 is the scanning electron microscope (SEM) picture showing the result of the surface structure and the contact angle of the films, which are prepared by the suspensions with different weight percent of dispersant/carbon nanotube;

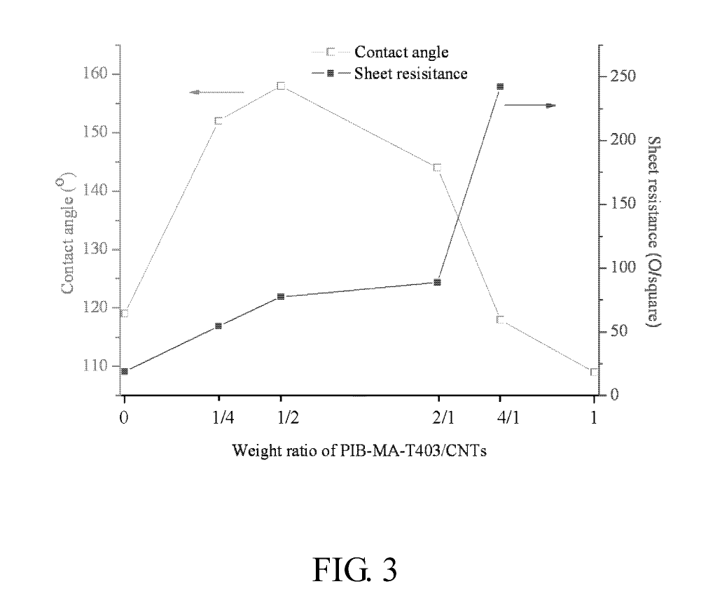

FIG. 3 shows the contact angle and the resistance influenced by different content of the dispersant;

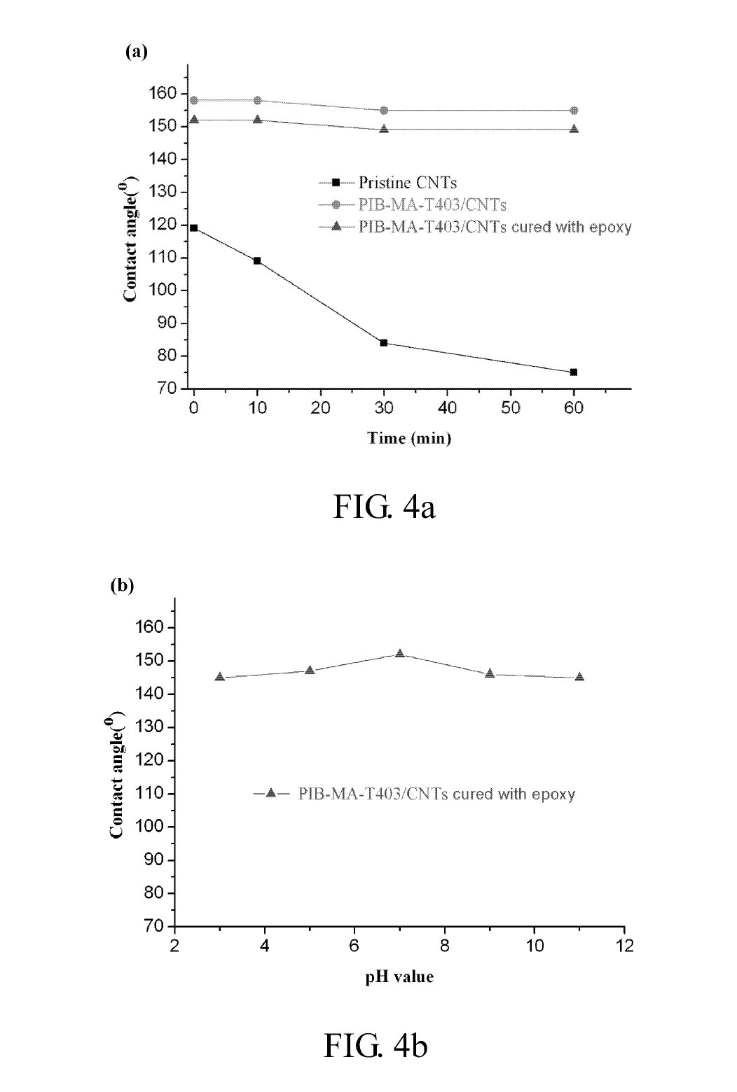

FIG. 4a shows the contact angle monitoring lengthy; and

FIG. 4b shows the contact angles of the water drops with different PH value.

### DETAILED DESCRIPTION

To fully understand the purpose, feature and function of this invention, this invention is described as below by utilizing the preferred embodiments and the drawings:

Material:

(1) Carbon nanotube (abbr. CNTs): purchased from Seedchem Company Pty., Ltd.; the purity is 95% and comprising 5% catalyst (Fe, Co and Ni); the diameter is 10-60 nm and the length is 0.5-10 μm.

(2) Polyisobutylene-g-maleic anhydride (abbr. PIB-MA): purchased from Chevron Corp.; the molecular weight is 950.

(3) Poly(oxypropylene)-triamine (abbr. T403): purchased from Huntsman Chemical Co.; the molecular weight is 440.

(4) bisphenol-A diglycidyl ether type epoxy resin: purchased from Chang Chun Plastics Co., Ltd.; the product name is BE-188; the epoxy equivalent is 188.

nPreparation Example 1: polyisobutene amine copolymer synthesis

It was synthesized by poly(oxypropylene)-triamine and polyisobutylene-g-maleic anhydride copolymer with mole ratio 1:1. The synthesis step is described as below:

Step 1: adding the poly(oxypropylene)-triamine (4.4 g, 0.01 mol) into 100 ml reactor and then adding THF as solvent.

Step 2: dissolving polyisobutylene-g-maleic anhydride copolymer in the THF solvent.

Step 3: adding the solution resulting from step 2 into reactor mentioned in step 1 slowly and stirring mechanically at room temperature for 3 hours.

Step 4: monitoring the reaction by using the FT-IR spectrometer and sampling every time interval until the absorption peak of anhydride was disappeared and the absorption peak of amide was not increasing, observed by FT-IR. The obtained fully-reacting product is a reddish orange thick liquid. The reaction flow chart is shown as below:

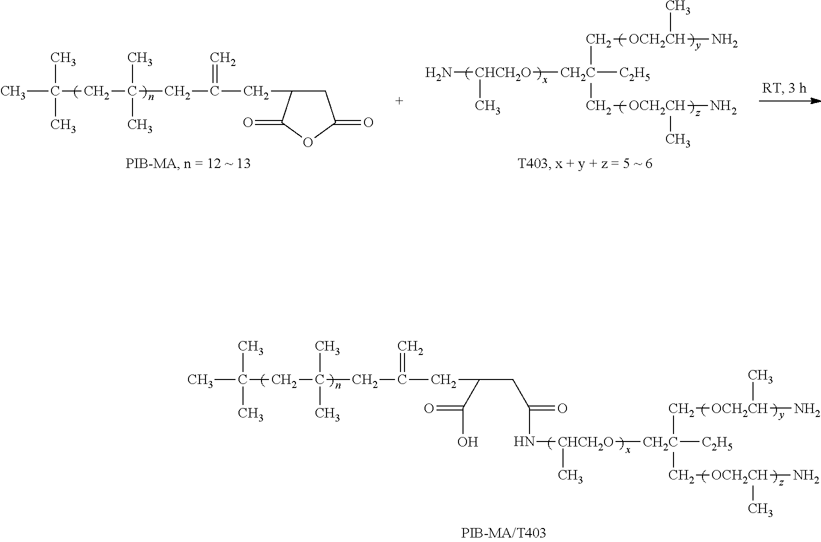

### EXAMPLE 1

### Preparation of Carbon Nanotube Superhydrophobic Film

Step 1: dissolving the polyisobutene amine copolymer in the solvent and stirring in the tube for about 5 minutes.

Step 2: adding the carbon nanotube into the tube resulting from step 1 and dispersing by using the ultrasonic for 5 times, 10 minutes per time.

Step 3: adding bisphenol-A diglycidyl ether type epoxy resin into the tube resulting from step 2 and stirring for about 5 minutes, wherein the weight percent of the polyisobutene amine copolymer, carbon nanotube and epoxy resin is free distributed from 0.1˜100:1:20˜500.

Step 4: coating the suspension resulting from step 3 on a glass substrate, increasing the temperature to 150° C. and heating for 3 hours to cure and form a superhydrophobic film.

FIG. 1 is the Transmission Electron Microscopy (TEM) picture showing the dispersion of the carbon nanotube dispersed in the solvent. The carbon nanotube is dispersed in the solvent stably by using the polyisobutene amine copolymer as a dispersant. FIGS. 1a and 1b show the carbon nanotube solution without adding the dispersant. The carbon nanotubes show aggregated phenomenon. FIGS. 1c and 1d show the solution with polyisobutylene-g-maleic anhydride. The carbon nanotube is aggregated in part and dispersed in part. As a whole, the dispersion effect is not good. As shown in FIGS. 1e and 1f, the carbon nanotubes are dispersed in the solvent stably by adding the polyisobutene amine copolymer as a dispersant. The carbon nanotube is tubular material constituted by sp² conjugate structure. The diameter of the tubular material is about 1-100 nm. The length is about—several micrometers. There are a strong hydrophobic segment on the one end and an amino group on the other end of the structure of polyisobutene amine copolymer. The strong hydrophobic segments exclude each other. Thus, the lone pair electrons contained in the amino group generated a covalent bond with the surface of the carbon nanotube.

FIG. 2 is the scanning electron microscope (SEM) picture showing the result of the surface structure and the contact angle of films, which are prepared by suspensions with different weight percent of dispersant/carbon nanotube, by measuring the contact angle with water and the SEM to observe the relationship of the weight percent. FIGS. 2a and 2b show the surface of original carbon nanotube and the surface of pure polymer and the contact angle thereof, respectively. There are many independent intertwined carbon tubes on the surface of the original carbon nanotube. However, the surface of the pure polymer is a smooth surface. As shown in FIGS. 2c to 2f, when the weight percent of the dispersant/carbon nanotube is 1/4, 1/2, 2/1, and 4/1; the contact angle is 152 degree, 158 degree, 144 degree and 118 degree, respectively. The preferred contact angle is 158 degree when the weight percent of the dispersant/carbon nanotube is 1/2. In FIG. 2d, the SEM figure shows that the roughness for the nanometer and the micrometer is provided. The superhydrophobic characteristic is also provided because of the lotus-leaf-like surface structure and the hydrophobic chemical property of the polyisobutene.

FIG. 3 shows influence of different content of the dispersant to the contact angle and the resistance. The preferred contact angle, 158 degree, is obtained when the weight percent of the dispersant/carbon nanotube (PIB-MA-T403/CNTs) is 1/2. The contact angle decreased as the content of the dispersant increased. The resistance increased as the dispersant increased. It is proved that the surface configuration of the superhydrophobic film can be adjusted by the weight percent of the dispersant/carbon nanotube; the contact angle and the resistance can also be adjusted thereby.

FIGS. 4a and 4b show the durability and the stability of the superhydrophobic film are confirmed by the contact angle lengthy monitoring and strong acid/base environment testing. FIG. 4a shows the contact angle monitored lengthy. The contact angle of the film, which is coated with only the original carbon nanotube, decreased from 120 degree to 75 degree within 30 minutes. After lengthy testing, the contact angle of the film, which is coated with the polyisobutene amine without epoxy resin and the carbon nanotube suspension (PIB-MA-T403/CNTs) or with polyisobutene amine cured with epoxy resin and the carbon nanotube suspension (PIB-MA-T403/CNTs cured with epoxy), still maintained above 150 degree. The standard of the superhydrophobic is satisfied. It means that the superhydrophobic film has property of long durability and stability. FIG. 4b shows the contact angle of the water drop with different pH value. When the pH value is changed from 1 to 13, the variation of the contact angle is small. It means that the superhydrophobic film still maintains the superhydrophobic property in the acid or base environment.

Example 1 synthesis the polyisobutene amine copolymer acting as a dispersant by reacting the polyisobutylene-g-maleic anhydride and poly(oxypropylene)-triamine. The carbon nanotube dispersed stably after ultrasonic vibration. The polyisobutene amine copolymer and the carbon nanotube are then coated on the film prepared on the substrate. The superhydrophobic property of the film is provided because of the roughness resulting from the gathered carbon nanotubes and the low surface energy of chemical property of the polyisobutene amine. The static contact angle is adjustable from 140 degree to 160 degree. Moreover, at the same time, the polyisobutene amine also can be a curing agent which can proceed the curing reaction with bisphenol-A diglycidyl ether type epoxy resin. The carbon nanotubes/polyisobutene amine/epoxy resin composite film thus prepared is of a tough stable structure and remains superhydrophobic when subjected to lengthy immersion treatment, exposure to a strong acid-base environment, or physical abrasion and polishing.

The carbon nanotubes superhydrophobic film with superhydrophobic, strength anti-polishing properties prepared by this invention is formed by the carbon nanotubes using a block polymer as a dispersant, stably in the organic solvent through the delamination dispersing and simple coating and solvent evaporation. This invention solves problems of the conventional technology, such as environment pollution generated by the fluorine-contained material, high cost and complicated procedure, etc. It has economical value for waterproof, self-cleaning, decreasing the resistance of water flow, anti-electromagnetic wave and anti-static electricity surface, etc.

As above-mentioned, this invention meets three requirements of patentability: novelty, non-obviousness and industrial applicability. As for the novelty and non-obviousness, the carbon nanotube suspension disclosed in this invention is effective in preparing a superhydrophobic film without undergoing chemical modification or the presence of a fluorine-containing compound. The superhydrophobic film thus prepared is of a tough stable structure and remains superhydrophobic when subjected to lengthy immersion treatment, exposure to a strong acid-base environment, or physical abrasion and polishing. As for the industrial applicability, the derivation products of this invention meet the requirement of the market.

While the present invention has been particularly shown and described with respect to preferred embodiments thereof, it will be understood by those skilled in the art that the embodiment only used to describe the present invention and not to limit the scope of the invention. It should be noted that any changes or replacement will fall within the scope of the present invention. Thus, the scope of present invention should be determined by appended Claims.

What is claimed is:

1. A carbon nanotube suspension includes a plurality of carbon nanotubes and a block copolymer dispersant which are evenly distributed in a solvent, wherein the block copolymer includes a hydrophobic block and a functional group block, such that the carbon nanotubes react with the functional group block to form covalent bonds directly without undergoing chemical modification.

2. The carbon nanotube suspension according to claim 1, further comprising a thermosetting resin.

3. The carbon nanotube suspension according to claim 1, wherein the thermosetting resin is epoxy resin.

4. The carbon nanotube suspension according to claim 3, wherein the epoxy resin is bisphenol-A diglycidyl ether.

5. The carbon nanotube suspension according to claim 1, wherein the functional group is a functional group with lone-pair electrons.

6. The carbon nanotube suspension according to claim 5, wherein the functional group is amino group.

7. The carbon nanotube suspension according to claim 1, wherein the hydrophobic block is a polyolefin with 10 to 30 carbon atoms.

8. The carbon nanotube suspension according to claim 7, wherein the polyolefin is a polyisobutylene.

9. The carbon nanotube suspension according to claim 1, wherein the block copolymer is a polyisobutene amine copolymer.

10. The carbon nanotube suspension according to claim 9, wherein the polyisobutene amine copolymer is obtained by reacting the polyisobutylene-g-maleic anhydride and poly(oxypropylene)-triamine.

11. The carbon nanotube suspension according to claim 1, no fluorides is contained.

12. The carbon nanotube suspension according to claim 1, wherein the weight percent of the block copolymer dispersant and the solvent is lower than 5 wt %.

13. The carbon nanotube suspension according to claim 1, wherein the weight percent of the nanotube and the solvent is lower than 1 wt %.

14. The carbon nanotube suspension according to claim 2, wherein the weight percent of the block copolymer dispersant, the nanotube and the thermosetting resin is 0.1˜100:1:20˜500.

15. A superhydrophobic film formed by coating and then drying the nanotube suspension prepared according to claim 1, the static state contact angle with water is 140 to 160 degree.

16. The superhydrophobic film according to claim 15, wherein the conductivity is 10⁻⁴ to 10¹ (S/cm).

17. The superhydrophobic film according to claim 15, wherein the hydrophobic and the conductivity is controllable by adjusting the weight percent of the block copolymer dispersant and the carbon nanotube.

18. The superhydrophobic film according to claim 16, wherein the hydrophobic and the conductivity is controllable by adjusting the weight percent of the block copolymer dispersant and the carbon nanotube.
